(19) United States
(12) Patent Application Publication
(10) Pub. No.: US 2009/0078800 A1
(43) Pub. Date: Mar. 26, 2009

(54) ELECTROSTATIC ATOMIZER AND HOT AIR BLOWER HAVING THE SAME

(75) Inventors: Hidetoshi NAKASONE, Hikone (JP); Itaru SAIDA, Hikone (JP); Hiromitsu MIYATA, Hikone (JP)

Correspondence Address: GREENBLUM & BERNSTEIN, P.L.C., 1950 ROLAND CLARKE PLACE, RESTON, VA, 20191, US

(73) Assignee: MATSUSHITA ELECTRIC WORKS, LTD., Osaka (JP)

(21) Appl. No.: 12/212,711

(22) Filed: Sep. 18, 2008

(30) Foreign Application Priority Data
Sep. 21, 2007 (JP) 2007-245170

(51) Int. Cl. B05B 5/00; A45D 20/10

(52) U.S. Cl. 239/690; 392/385

(57) ABSTRACT

There is provided an electrostatic atomizer that electrostatically atomizes a liquid supplied to a discharge electrode by electric discharge caused by an electric field formed in response to voltage application to the discharge electrode. The electrostatic atomizer has a high-voltage generation circuit that generates a pulse voltage to be applied to the discharge electrode, and the high-voltage generation circuit includes a high-voltage control circuit that converts an input AC signal to a pulse signal, and an igniter that steps up the pulse signal obtained by the high-voltage control circuit to a voltage value of the pulse voltage to be applied to the discharge electrode.

### CROSS REFERENCE TO RELATED APPLICATION

This application is based upon and claims the benefit of priority from a Japanese Patent Application No. TOKUGAN 2007-245170, filed on Sep. 21, 2007; the entire contents of which are incorporated herein by reference.

### BACKGROUND OF THE INVENTION

1. Field of the Invention

The present invention relates to an electrostatic atomizer that produces charged liquid particles, and also to a hot air blower provided with the electrostatic atomizer and an air blowing unit that delivers heated air.

2. Description of the Related Art

As conventional devices of this kind, there has been known a device disclosed in Japanese Patent Application Laid-Open No. 11-300975. According to the technology adopted for a liquid atomizer disclosed in the patent application, the liquid atomizer has an emitting electrode submerged in liquid and a counter electrode disposed opposite to the emitting electrode outside the liquid, and by supplying a pulse voltage having a controlled pulse width to the emitting electrode and then activating the liquid atomizer, generation of fine particles each having different particle size can be controlled for each particle, so that minute particles with less variations in size can be generated with very high density at a low voltage.

In this conventional liquid atomizer, the pulse width control and the pulse voltage adjustment alone are not enough to improve the performance of electrostatic atomization in a high electric field, and therefore, increase in electrostatic charge on each particle and reduction in the particle size have been desired for further improvement of the performance of electrostatic atomization.

Furthermore, in this conventional atomizer, a pulse supplied from a pulse supply unit is used for an electrode activation controller to generate a pulse voltage applied to the emitting electrode. Therefore, the pulse supply unit needs to be provided, which advantageously leads to an increase of parts count and a complicated circuit structure.

The present invention has been achieved in view of these problems, and an object of the invention is to provide an electrostatic atomizer that can further reduce the particle size of charged liquid particles thereby to improve the performance, and that is downsized and simplified in its structure. Another object of the invention is to provide a hot air blower that can deliver heated air and emit fine charged liquid particles.

### SUMMARY OF THE INVENTION

To achieve the above objects, the present invention provides an electrostatic atomizer that electrostatically atomizes a liquid supplied to a discharge electrode by electric discharge caused by an electric field formed in response to voltage application to the discharge electrode. The electrostatic atomizer comprises a voltage generation unit that generates a pulse voltage to be applied to the discharge electrode, and the voltage generation unit includes a conversion unit that converts an input AC signal to a pulse signal and an igniter that steps up the pulse signal obtained by the conversion unit to a voltage value of the pulse voltage to be applied to the discharge electrode.

### BRIEF DESCRIPTION OF THE DRAWINGS

Examples of the invention will become more fully apparent from the following description and appended claims, taken in conjunction with the accompanying drawings. Understanding that these drawings depict only examples and are, therefore, not to be considered limiting of the invention's scope, the examples of the invention will be described with additional specificity and detail through use of the accompanying drawings in which:

FIG. 1 shows a configuration of an electrostatic atomizer according to a first embodiment of the present invention;

FIG. 2 is a voltage waveform chart of the electrostatic atomizer;

FIG. 3 shows circuit structures of a high-voltage control circuit and a smoothing/rectifying circuit;

FIG. 4 shows a relation between an electric field and fine liquid particles that is observed at electrostatic atomization;

FIG. 5 is a voltage waveform chart of a voltage applied to a discharge electrode;

FIG. 6 shows a relation between the voltage applied to the discharge electrode and a discharge current at an electric discharging time;

FIG. 7 shows a configuration of an electrostatic atomizer according to a second embodiment of the present invention; and

FIG. 8 shows a structure of a hot air blower according to a third embodiment of the present invention provided with the electrostatic atomizer.

### DETAILED DESCRIPTION OF THE PREFERRED EMBODIMENTS

Preferred embodiments of the present invention are explained below with reference to the drawings.

### First Embodiment

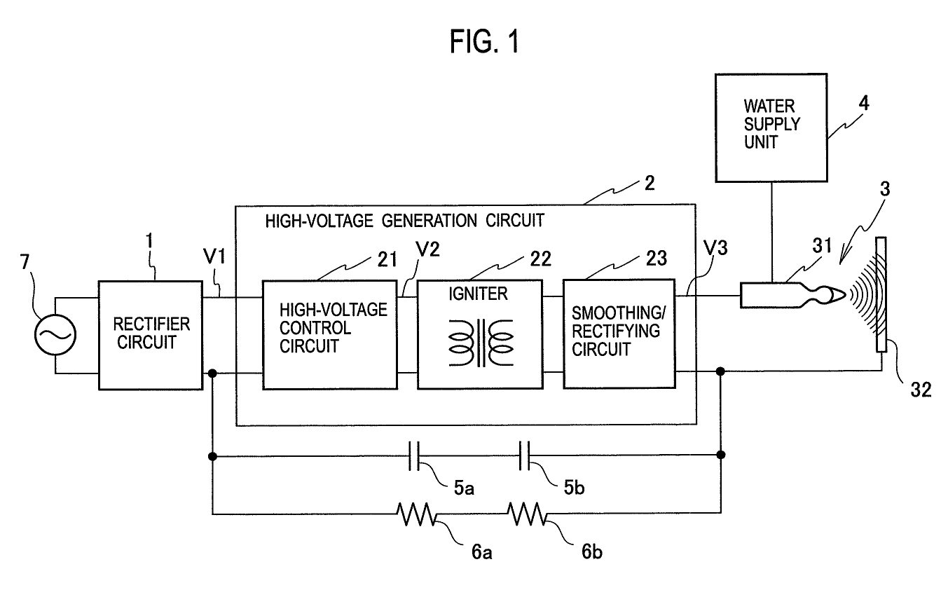

FIG. 1 shows a configuration of an electrostatic atomizer according to a first embodiment of the present invention.

With reference to FIG. 1, the electrostatic atomizer has a rectifier circuit 1, a high-voltage generation circuit 2, a discharge unit 3, a water supply unit 4, a capacitor 5 (5a, 5b), and a resistor 6 (6a, 6b).

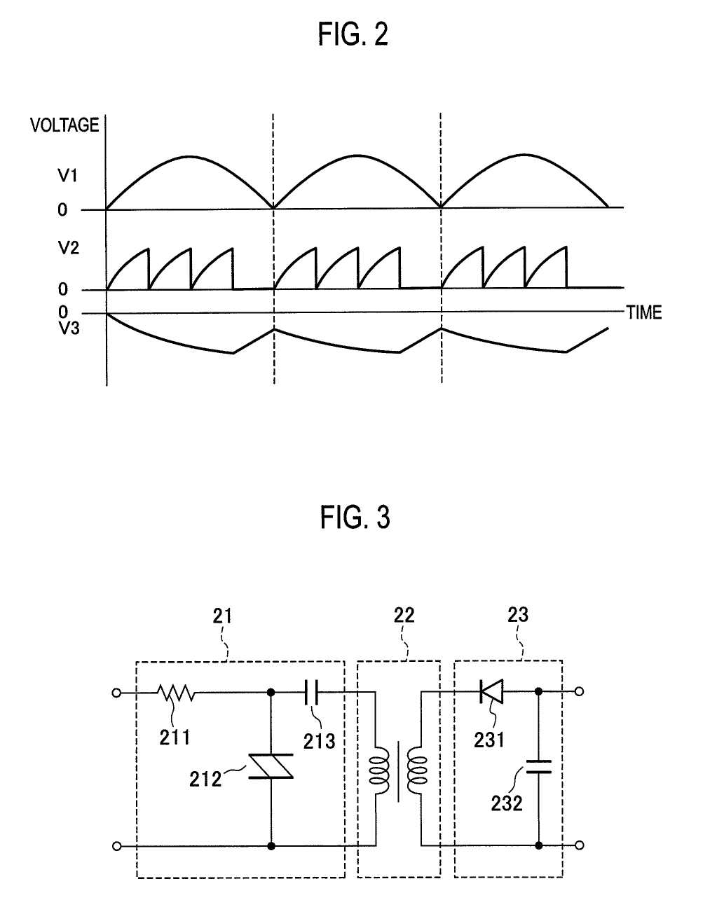

The rectifier circuit 1 rectifies an alternating current supplied from a commercial AC power supply 7 by full-wave rectification or half-wave rectification, and in the case of the full-wave rectification, the rectifier circuit 1 supplies the high-voltage generation circuit 2, a rectified signal such as that shown by V1 in a voltage waveform chart of FIG. 2.

The high-voltage generation circuit 2 includes a high-voltage control circuit 21, an igniter 22 operable as a step-up transformer, and a smoothing/rectifying circuit 23, and steps up the rectified voltage V1 supplied from the rectifier circuit 1 to generate a high-voltage pulse signal.

Upon receipt of the rectified signal from the rectifier circuit 1, the high-voltage control circuit 21 generates based on this rectified signal, a pulse-form signal which has a frequency higher than that of a commercial AC voltage and which is suitable for input to the igniter 22, that is, suitable for the step-up operation of the igniter 22. This pulse-form signal is, for example, a pulse signal shown by V2 in the voltage waveform chart of FIG. 2. The generated pulse signal is supplied to the igniter 22.

The igniter 22 has a primary coil connected to the high-voltage control circuit 21 and a secondary coil connected to the smoothing/rectifying circuit 23, and steps up the pulse voltage supplied from the high-voltage control circuit 21 thereby to generate a positive or negative high pulse voltage about −3 kV to 4 kV, which is set in advance at the secondary coil. The generated pulse voltage is supplied to the smoothing/rectifying circuit 23.

Upon receipt of the stepped-up pulse voltage having a frequency higher than that of the AC power supply 7, the smoothing/rectifying circuit 23, which is connected to the secondary coil of the igniter 22, smoothes and rectifies the pulse voltage thereby to generate a pulse signal whose frequency has been reduced to approximately the frequency of the AC power supply 7, for example, a negative-voltage pulse signal such as that indicated by V3 in the voltage waveform chart of FIG. 2. The generated pulse signal is supplied to the discharge unit 3.

The discharge unit 3 has a discharge electrode 31, and a counter collecting electrode that produces a high electric field with the discharge electrode 31 therebetween, and that is, for example, a ground electrode 32. Electric discharge in the high electric field produces charged (e.g., negatively charged) particulate water (ionized mist, simply referred to as ion mist hereinbelow) and charged (e.g., negatively charged) ions, so that electrostatic atomization is achieved.

In the first embodiment and other embodiments explained later, water is handled as a liquid to be atomized, but the liquid is not limited to water, and can be, for example, a liquid prepared by adding another substance into water and mixing them together.

The discharge electrode 31 is connected to a terminal provided on a side of high voltage output of the smoothing/rectifying circuit 23, and the high pulse voltage obtained by the smoothing/rectifying circuit 23 is applied to this discharge electrode 31. The ground electrode 32 is disposed away at a predetermined distance from the discharge electrode 31, and a grounding potential is given thereto. The ground electrode 31 and the discharge electrode 32 produce a high electric field therebetween to perform electric discharge.

The water supply unit 4 supplies water used for electrostatic atomization performed by the discharge unit 3. The water supply unit 4 has a tank for storing, for example, water, and supplies the water stored in the tank to the discharge electrode 31. Alternatively, the water supply unit 4 has, for example, a Peltier module, as a cooling unit that cools the discharge electrode 31 below the dew point to obtain condensed water of the discharge electrode 31.

As mentioned earlier, when a liquid other than water is used for electrostatic atomization, the liquid prepared in advance can be stored in the tank, instead of storing water.

The capacitor 5 is constituted by two capacitors 5a and 5b that are connected in series between a terminal provided on a side of low voltage output of the smoothing/rectifying circuit 23 and the AC power supply 7. The capacitor 5 serves as a high-frequency low-impedance element to connect the terminal on the low-voltage output side of the smoothing/rectifying circuit 23 and the AC power supply 7.

The resistor 6 is constituted by two resistors 6a and 6b that are connected in series between the terminal provided on the low-voltage output side of the smoothing/rectifying circuit 23 and the AC power supply 7. The resistor 6 serves as an element that ensures stable operations of the circuit and connects the terminal on the low-voltage output side of the smoothing/rectifying circuit 23 and the AC power supply 7.

The high-voltage control circuit 21 and the smoothing/rectifying circuit 23 shown in FIG. 1 are configured, for example, as shown in FIG. 3.

As shown in FIG. 3, the high-voltage control circuit 21 has a resistor 211, a switching device 212, such as a SIDAC, that switches when it has reached a preset reference voltage, and a capacitor 213. The smoothing/rectifying circuit 23 has a diode 231 and a capacitor 232. When the high-voltage control circuit 21 receives input of the rectified signal from the rectifier circuit 1, the capacitor 213 is charged via the resistor 211, and when the charge voltage has reached the reference voltage, the switching device 212 switches from OFF to ON and is accordingly energized. The charge voltage charged in the capacitor 213 is applied to the igniter 22 via the switching element 212, and afterwards, the voltage of the capacitor 213 falls below the reference voltage, whereupon the switching device 212 switches to OFF. This operation is repeated thereby to generate the pulse signal as shown by V2 of FIG. 2, which has been explained earlier.

With such a configuration, the voltage of the pulse signal generated by the high-voltage generation circuit 2 is set to a high voltage (ion mist emission voltage) such that ion mist is produced by electric discharge of the discharge unit 3 and also that leakage does not occur when this voltage is applied to the discharge electrode 31, and the voltage is about −3.3 kV, for example, although it is different depending on the duration of the voltage application.

When this high voltage is applied to the discharge electrode 31, a high electric field is produced between the discharge electrode 31 and the ground electrode 32. To the discharge electrode 31, water is supplied from the water supply unit 4. In this state, while the pulse signal is being applied to the discharge electrode 31, the water supplied to the discharge electrode 31 is electrostatically atomized because of the high electric field produced between the discharge electrode 31 and the ground electrode 32 as described above, and consequently ion mist is produced. The produced ion mist is bearing electrostatic charges, and hence migrates from the discharge electrode 31 to the ground electrode 32 because there is the high electric field therebetween. This migrating ion mist is emitted outside efficiently by virtue of an air flow from an air blowing unit such as a fan. Note that the produced ion mist can be emitted even without the air blowing unit, but the emission efficiency can be further increased by utilizing it.

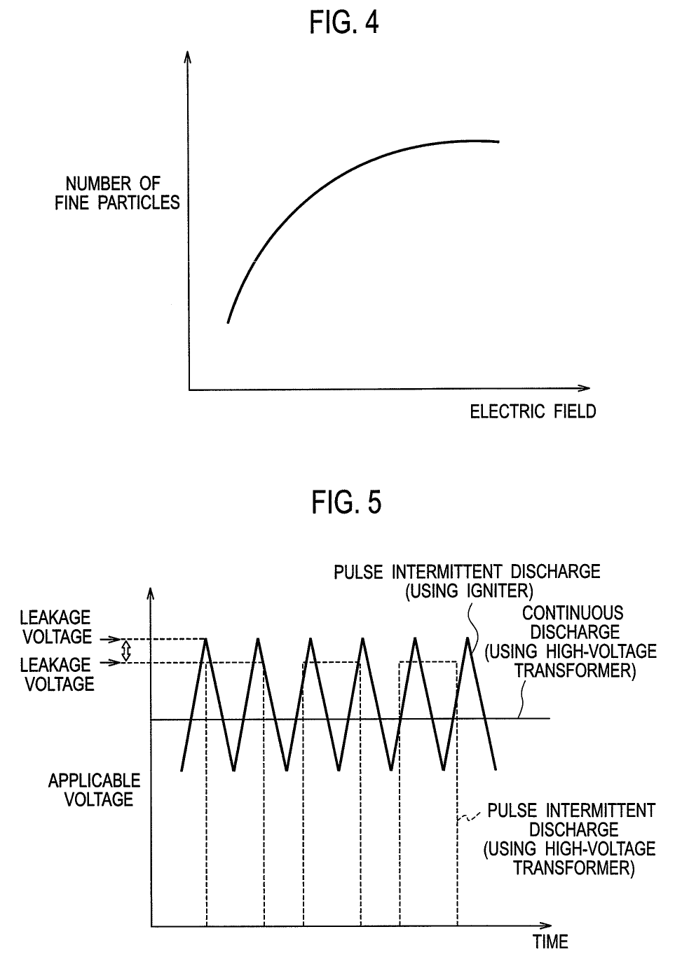

As described above, according to the first embodiment, by applying the pulse signal to the discharge electrode 31, a high electric field can be produced between the discharge electrode 31 and the ground electrode 32 without causing a leakage current during electric discharge operations. Producing of the high electric field increases discharged energy per a particle emitted, and electrostatic atomization under the high electric field conditions can also increase the electrostatic charge on the ion mist. Furthermore, the relation between the electric field intensity during the discharge operations and the number of particles having reduced to a certain minute size exhibits a characteristic as shown in FIG. 4, which means that higher electric field leads to an increase in the number of ion mist particles that have been reduced to a certain size, such as approximately 5 nm.

A possible method for further increasing the intensity of the electric field compared to conventional ones is to raise a voltage applied to the discharge electrode, but when the applied voltage is raised, a leakage current can be generated. In order to overcome this problem, as explained in the first embodiment, the applied voltage is changed from a continuously constant voltage signal to an intermittent pulse signal, so that the applied voltage can be raised without causing the leakage current.

Meanwhile, when the igniter, which is adopted to input a pulse signal in the first embodiment, is not used but a common step-up transformer that inputs a high-frequency sine wave is used to generate a pulse signal, it is necessary to supply a high-frequency, intermittent signal suitable for input to the step-up transformer from the high-voltage control circuit 21 to this step-up transformer. Therefore, a circuit structure to generate such a signal is required, which can increase parts count and circuit size, and make the circuit structure more complicated.

In the first embodiment, instead of a common step-up transformer, the igniter is adopted to input the pulse-form signal and step up the applied voltage, which realizes a small-sized, simple structure, compared to the case that a common step-up transformer is used. Furthermore, as shown in FIG. 5, when the igniter is adopted, the output time (application time) of the maximum voltage applicable to the discharge electrode without causing the leakage current can be shortened, compared to the case that a common step-up transformer is used (high-voltage transformer method), so that the applied voltage can be set to a large value thereby to produce a high electric field.

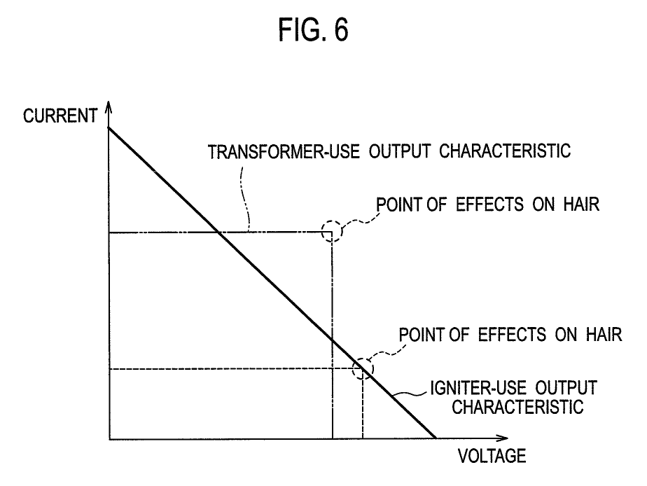

When a constant voltage is continuously applied to the discharge electrode, the applied voltage has been low compared to the case that the pulse signal is applied, in order to prevent the leakage current as described above. Therefore, in order to generate ion mist and obtain effects thereof, a discharge current value to generate the ion mist has been required. Assuming that the ion mist is applied to hair to obtain effects thereon, this discharge current value is a value indicated by a point on a transformer-use output characteristic (voltage at constant voltage application—current characteristic) at which effects appear on the hair, which is shown in FIG. 6. This discharge current value is larger than that indicated by a point on an igniter-use output characteristic (voltage at pulse voltage application—current characteristic) at which effects appear on the hair, which is also shown in FIG. 6, thereby causing an increase in current consumption.

In the first embodiment, a high voltage can be obtained easily, which makes it possible to lower the discharge current required to generate the ion mist. Therefore, the current consumption can be reduced.

### Second Embodiment

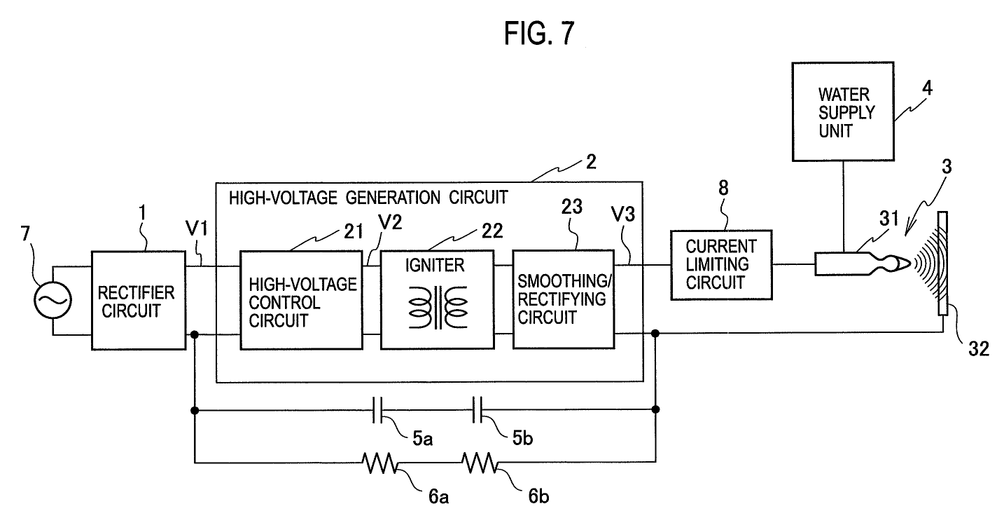

FIG. 7 shows a configuration of an electrostatic atomizer according to a second embodiment of the present invention.

With reference to FIG. 7, the second embodiment is characterized such that a current limiting circuit 8, for example, a resistor, is provided between the smoothing/rectifying circuit 23 of the high-voltage generation circuit 2 and the discharge electrode 31 of the discharge unit 3 in order to limit a current of a high-voltage pulse signal that is obtained from the high-voltage generation circuit 2 and applied via this current limiting circuit 8 to the discharge electrode 31.

By using this current limiting circuit 8 to limit the current of the pulse signal applied therethrough to the discharge electrode 31, stable generation of ion mist is ensured, in addition to the advantages achieved in the first embodiment.

### Third Embodiment

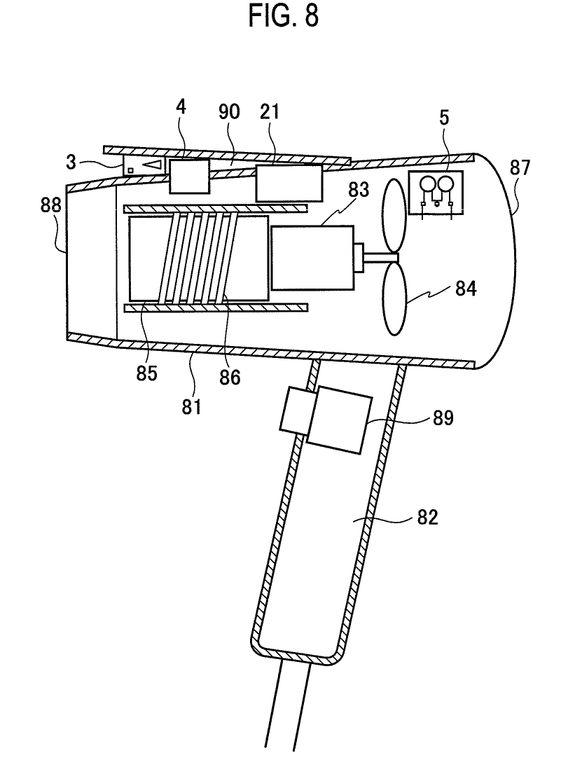

FIG. 8 is a schematic diagram of a structure of a hair dryer, which is an example of a hot air blower according to a third embodiment of the present invention provided with the electrostatic atomizer shown in FIG. 1 or FIG. 7.

With reference to FIG. 8, the hair dryer has a housing 81 that forms a main unit, and also has a handle 82 that is integral with the housing 81 and provided on a lower wall of the housing 81 so as to protrude downward. In the housing 81, provided are a fan 84 for intake of air from an air intake port 87, and a motor 83 for rotating the fan 84. At a downstream side of the motor 83, a heating unit 85 is provided on which a heater 86 is disposed to selectively heat the air delivered by the fan 84 and generate warm air when the heater 86 is selectively electrically charged, where the generated warm air is sent through a blow-out port 88 to the outside.

On the handle 82, a switch 89 is provided which switches on/off the motor 83, the heater 86, and the electrostatic atomizer, and also switches other functions of the hair dryer.

In a front part of an upper wall of the housing 81, the high-voltage generation circuit 2, the discharge unit 3, and the water supply unit 4, which compose the electrostatic atomizer shown in FIG. 1 or FIG. 7 together with the rectifier circuit 1 (not shown), are arranged. Ion mist generated by the discharge unit 3 is emitted in the same direction as that of the air blown from the blow-out port 88, by an air flow generated by the fan 84 and then introduced into an introduction path 90.

On the upper wall within the housing 81 between the air intake port 87 and the fan 84, the capacitor 5 is arranged and connected to the high-voltage generation circuit 2 via a wire (not shown).

As described above, by installing the electrostatic atomizer according to the first embodiment shown in FIG. 1 or the electrostatic atomizer according to the second embodiment shown in FIG. 7 on a hair dryer as a hot air blower, it is possible to reduce the ion mist particles emitted from the dryer to fine particle size, increase the electrostatic charge on the ion mist, and also increase the volume of the ion mist having the fine particle size. This enhances permeability of the ion mist into hair, and improves a moisturizing effect on hair.

Furthermore, by setting a voltage amplitude of the pulse signal applied to the discharge electrode 31 between a charged-ion emission voltage and an ion-mist emission voltage, it is possible to provide effective factors, that is, one or both of ions providing a blow-dry effect and ion mist providing a moisturizing effect can be always emitted as long as the electrostatic atomizer is operating.

Although the present invention made by the present inventors has been described in reference to its embodiment, the statement and drawings constituting part of the disclosure of the present invention should not be regarded as limiting the present invention. That is, various alternative embodiments, examples, and operation techniques made by those skilled in the art on the basis of the foregoing embodiment are, of course, within the scope of the present invention.

What is claimed is:

1. An electrostatic atomizer that electrostatically atomizes a liquid supplied to a discharge electrode by electric discharge caused by an electric field formed in response to voltage application to the discharge electrode, comprising:
a voltage generation unit that generates a pulse voltage to be applied to the discharge electrode, wherein
the voltage generation unit includes:
a conversion unit that converts an input AC signal to a pulse signal; and
an igniter that steps up the pulse signal obtained by the conversion unit to a voltage value of the pulse voltage to be applied to the discharge electrode.

2. The electrostatic atomizer according to claim 1, further comprising a current limiting unit that limits a current value of the pulse voltage to be applied to the discharge electrode.

3. A hot air blower comprising:
the electrostatic atomizer according to claim 1; and
a hot air blowing unit that delivers warm air.
